(19) United States
(12) Patent Application Publication
(10) Pub. No.: US 2004/0215693 A1
(43) Pub. Date: Oct. 28, 2004

(54) Apparatus, methods and computer program products for power monitoring using networked UPS clients

(76) Inventor: Jim Thompson, Raleigh, NC (US)

Correspondence Address: MYERS BIGEL SIBLEY & SAJOVEC, PO BOX 37428, RALEIGH, NC, 27627, US

(21) Appl. No.: 10/397,506

(22) Filed: Mar. 26, 2003

(51) Int. Cl. G06F 15/16

(52) U.S. Cl. 709/201

(57) ABSTRACT

A power monitoring system comprises a plurality of uninterruptible power supplies (UPSs) and a communications network comprising a plurality of UPS clients coupled to respective ones of the UPSs and a UPS directory server in communication with the UPS clients. The UPS directory server is operative to categorize locations of the UPS clients in the communications network. For example, the UPS directory server may be operative to categorize locations of the UPS clients in the communications network based on categorization information received from the UPS clients, such as location information, power distribution network information, or communications network information. The UPS clients may be operative to communicate power status information based on communications network location information communicated by the UPS directory server, e.g., using peer-to-peer communications links established using the communications network location information communicated by the UPS directory server. The invention may be embodied as apparatus, methods and computer program products.

### BACKGROUND OF THE INVENTION

The present invention relates to power monitoring apparatus, methods and computer program products, and more particularly, to apparatus and methods for monitoring power using uninterruptible power supplies (UPSs).

A question that often arises when a utility customer loses service is “Is it me, or the whole grid?” Typically, a customer would like to immediately know if the former is the case, as the utility often will not rapidly address a local failure without being informed by the customer. Accordingly, it is generally desirable for a customer to be able to gain knowledge of the scope of an outage as soon as possible.

There are additional reasons for wanting to be timely informed of failures elsewhere in a power distribution network. For example, a utility customer may operate a data center or other sensitive facility. Although such facilities may use UPSs to provide backup power in the event of utility failure or degradation, it still may be advantageous to be informed of status of other portions of the power grid before a local failure actually occurs. For example, knowledge of nearby power grid events, such as nearby blackouts, brownouts or surges, could be used to trigger the bringing of a UPS or power conditioner on-line, which may reduce the likelihood of disruption of critical functions. Such knowledge could also be used to trigger a stepped up level of data backup procedures.

Systems for monitoring power networks have been proposed. For example, U.S. Pat. No. 6,437,692 to Petite et al. describes a system that utilizes a plurality of wireless transmitters that are placed at utility meters and that transmit sensed electrical system parameters to a wide area network (WAN) gateway interface that is coupled to a server computer that analyzes the sensed parameters. Such a system may be expensive to implement, and is likely to be installed and/or controlled by the utility. Accordingly, there is a need for a power monitoring system that can be accessed by customers, independent of the utility, and that can be provided at reasonable cost.

### SUMMARY OF THE INVENTION

According to some embodiments of the invention, a power monitoring system comprises a plurality of uninterruptible power supplies (UPSs) and a communications network comprising a plurality of UPS clients operative to monitory respective ones of the UPSs. A UPS directory server is in communication with the UPS clients, and is operative to categorize the UPS clients. For example, the UPS directory server may be operative to categorize locations of the UPS clients in the communications network based on categorization information received from the UPS clients, such as location (e.g., geographic) information, power distribution network information, and communications network information.

In further embodiments of the invention, the UPS clients are operative to communicate categorization information to the UPS directory server. The UPS directory server is operative to generate a categorization of the UPS clients based on the communicated categorization information and to communicate communications network location information to the UPS clients based on the generated categorization. The UPS clients may be operative to communicate power status information based on the communications network location information communicated by the UPS directory server. For example, the UPS clients may establish peer-to-peer communications links using the communications network location information communicated by the UPS directory server, and may communicate the power status information over the peer-to-peer communications links. The UPS clients may be operative to communicate requests for communications location information to the UPS directory server, and the UPS directory server may be operative to communicate communications network location information to the UPS clients responsive to the communicated requests. The invention may be embodied as apparatus, methods and computer program products.

Embodiments of the invention can provide several benefits. A network of UPS clients for monitoring status of a power distribution system can be established on an ad hoc basis, independent of the utility that maintains the power distribution network. Each customer can configure its own monitoring capability as it sees fit within a framework of agreed-upon rules regarding information exchange. Because power status information can be communicated in a peer-to-peer fashion, data traffic may be reduced in comparison to centralized monitoring systems. In addition, because a UPS may already include communications networking capability in the form of an Ethernet or other networking interface, or can be provided with such capability via a data processing device powered by the UPS, power monitoring apparatus and methods of the present invention can be provided in a relatively simple and cost-effective manner.

### BRIEF DESCRIPTION OF THE DRAWINGS

FIG. 1 illustrates a power distribution monitoring system according to some embodiments of the invention.

FIGS. 2-4 illustrate exemplary operations for power distribution system monitoring according to various embodiments of the invention.

### DETAILED DESCRIPTION

Specific exemplary embodiments of the invention now will be described with reference to the accompanying drawings. This invention may, however, be embodied in many different forms and should not be construed as limited to the embodiments set forth herein; rather, these embodiments are provided so that this disclosure will be thorough and complete, and will fully convey the scope of the invention to those skilled in the art. In the drawings, like numbers refer to like elements. It will be understood that when an element is referred to as being “connected” or “coupled” to another element, it can be directly connected or coupled to the other element or intervening elements may be present.

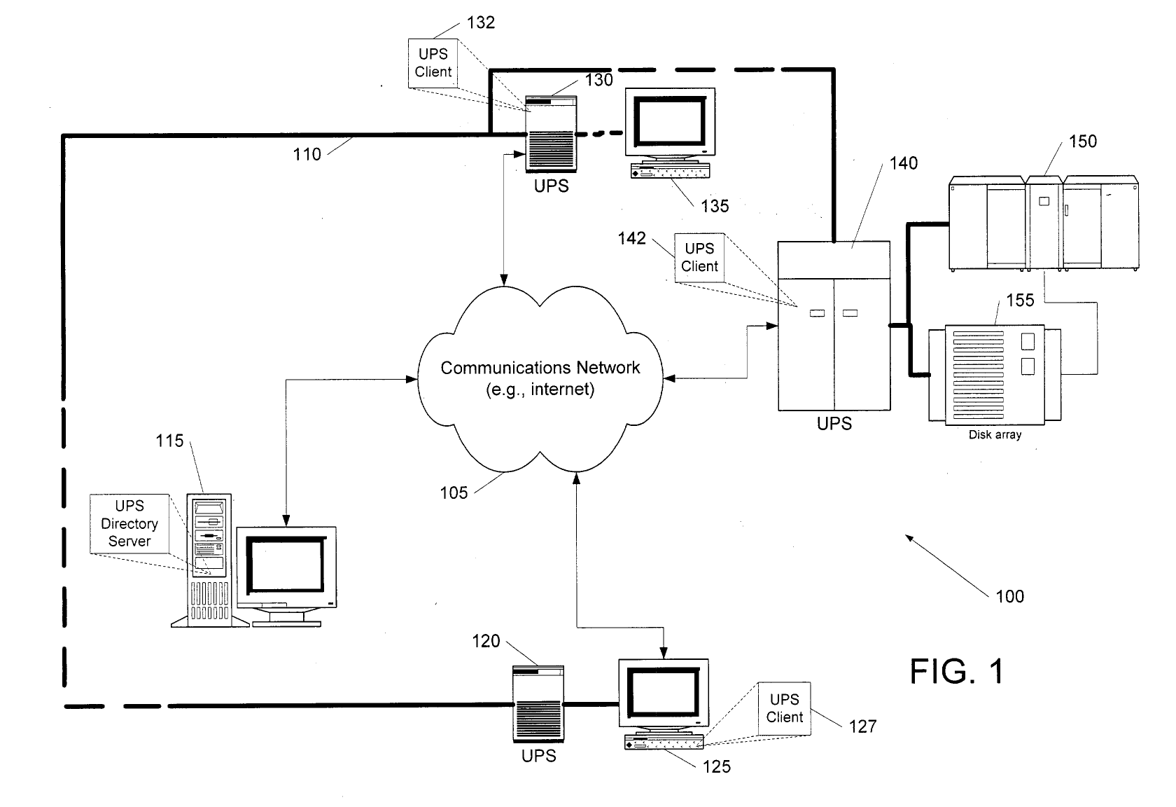

Exemplary embodiments of the invention will now be described with reference to FIGS. 1-4 and an exemplary protocol for communications among one or more UPS clients and a UPS directory server. It will be appreciated that the protocol described herein is exemplary, and can be supplemented, supplanted or otherwise modified within the scope of the invention.

FIG. 1 illustrates a system 100 according to some embodiments of the invention, including a plurality of UPS clients 127, 132, 142 and a UPS directory server 117 that serve as nodes of a communications network 105. The UPS clients 127, 132, 142 are associated with respective UPSs 120,130, 140 that are coupled to a power distribution network 110. The UPS clients 127, 132, 142 are operative to monitor the UPSs 120, 130, 140, and communicate with a UPS directory server 117.

The UPS clients 127, 132, 142 may be embodied in a number of different forms. For example, the UPS client 127 is shown embodied in a workstation 125 that is powered by a small-capacity UPS 120. For example, the UPS client 127 may include program code executing on the workstation 125 and configured to monitor status of the UPS 120 using, for example, a RS-232 or other communications interface. The UPS 132 is shown as embodied in the UPS 132 itself. For example, the UPS client 132 may include program code that executes in a communications interface circuit (e.g., network card) housed in the UPS and operative to monitor status of the UPS 130. The UPS client 142 is shown as embodied in a large-scale UPS 140 that powers a plurality of data processing components, such as a mainframe computer 150 and storage disk array 155. The UPS client 142 may, for example, be implemented by program code executing in a microprocessor or other circuitry that monitors and controls the UPS 140. Examples of communications interface circuitry that may be used in a UPS include ConnectUPS WEB/SNMP Cards, network cards that provide SNMP, HTTP, SMTP, WAP and Telnet compatibility and RS232 communications for UPS products distributed by the Powerware Corporation, generally described at http://www.powerware.com.

As shown in FIG. 1, the UPS directory server 117 may be embodied in a separate server computer 115. However, it will be appreciated that the UPS directory server 117 may be implemented in other devices, including other nodes in the network 105. According to various embodiments of the invention, a UPS directory server, such as the UPS directory server 117 of FIG. 1, is operative to categorize locations of the UPS clients 127, 132, 142 in the communications network 105, for example, based on power distribution network information, communications network information, location information or other categorization information associated with the UPSs 120, 130, 140.

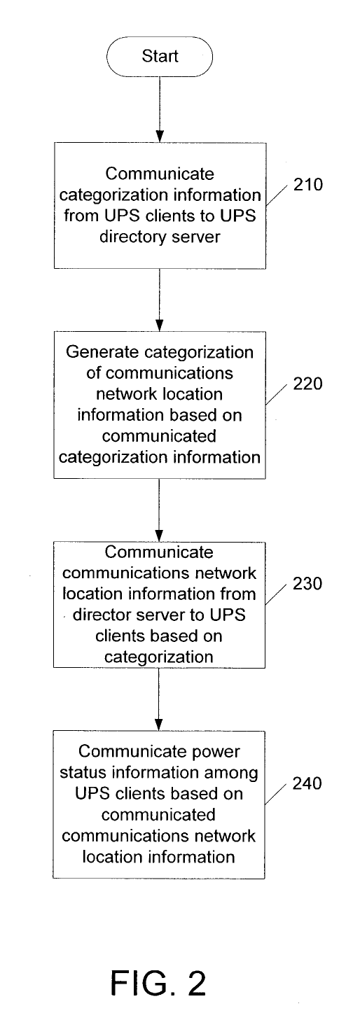

In the present application, FIGS. 2-4 are diagrams illustrating exemplary apparatus and operations according to embodiments of the present invention. It will be understood that operations depicted in the diagrams, and combinations thereof, may be implemented using one or more electronic circuits, for example, in a communications circuit of a networked device, such as a UPS or a computer that is operatively associated with a UPS. It will also be appreciated that, in general, operations depicted in the diagrams, and combinations thereof, may be implemented in one or more electronic circuits, such as in one or more discrete electronic components, one or more integrated circuits (ICs), one or more application specific integrated circuits (ASICs), and application specific circuit modules, as well as by computer program instructions which may be executed by a computer or other data processing apparatus, such as a microprocessor or digital signal processor (DSP), to produce a machine such that the instructions which execute on the computer or other programmable data processing apparatus create electronic circuits or other means that implement the specified operations. The computer program instructions may also be executed on one or more computers or other data processing apparatus to cause a series of actions to be performed by the computer(s) or other programmable apparatus to produce a computer implemented process that includes the specified operations.

The computer program instructions may also be embodied in the form of a computer program product in a computer-readable storage medium, i.e., as computer-readable program code embodied in the medium for use by or in connection with an instruction execution system. The computer-readable storage medium may include, but is not limited to, electronic, magnetic, optical or other storage media, such as a magnetic or optical disk or an integrated circuit memory device. For example, the computer program instructions may be embodied in memory included in a device, such as a computer or UPS. Accordingly, blocks of the diagrams of FIGS. 2-4 support electronic circuits and other apparatus that perform the specified operations, acts for performing the specified operations, and computer program products configured to perform the specified operations.

Referring to FIGS. 1 and 2, according to some embodiments of the invention, each of the UPS clients 127, 132, 142 may communicate UPS categorization information to the UPS directory server 117 via the communications network 105 (Block 210). “Categorization information” may include power distribution network location information, such as circuit designations (e.g., node and/or branch designations), or other information, such as geographic information, that is indicative of location in the power distribution network 110. For example, the UPS clients 127, 132, 142 may transmit ZIP code and/or latitude/longitude information to the UPS directory server 117. The UPS categorization information may include other types of information that may be useful in monitoring power status, such as information that can be used to classify a UPS based on a communications network device or component that it is associated with, such as a domain, subnetwork or the like. It will be appreciated that the categorization information may include combinations of the above-described types of information, and is not limited to the above-described types of information.

The UPS directory server 117 generates a categorization of locations, for example, internet addresses or other types of network addresses, of the UPS clients 127, 132, 142 in the communications network 105 based on the communicated categorization information (Block 220) and communicates communications network locations to the UPS clients 127, 132, 142 based on the categorization (Block 230). For example, in an exemplary protocol described below, the UPS directory server 117 may generate and transmit selected lists of network addresses to the UPS clients 127, 132, 142 based on geographic information associated with the UPS clients 127, 132, 142.

The UPS clients 127, 132, 142 may then communicate power status information among one another based on the communications network location information received from the UPS directory server 117 (Block 240). For example, as described below, the UPS clients 127, 132, 142 may establish peer-to-peer communications links that are used to periodically transmit power status information among the UPS clients 127, 132, 142 such that each UPS client is able to determine status of selected portions of the power distribution network 110.

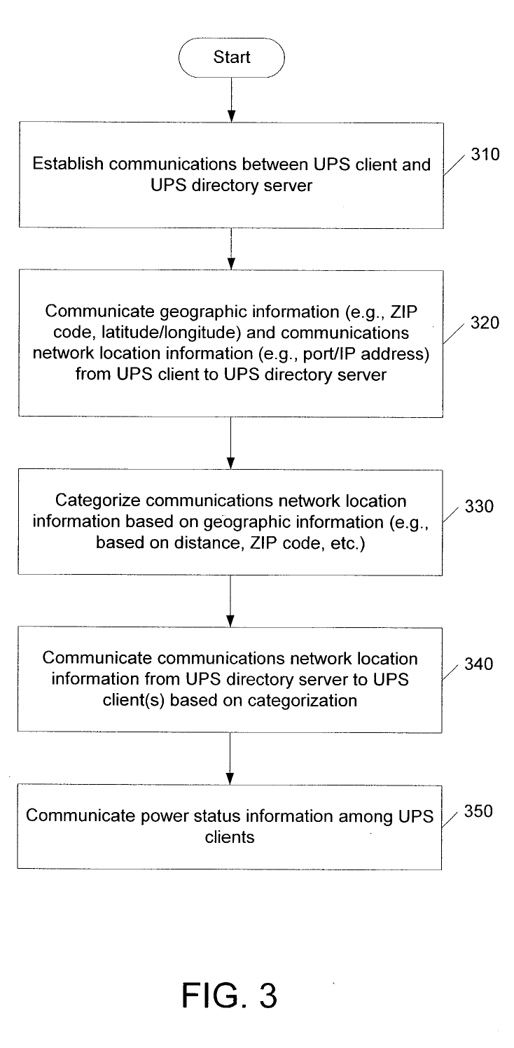

Exemplary operations for monitoring a power distribution network according to further embodiments of the invention are illustrated in FIG. 3. Communications between a UPS client and a UPS directory server are established (Block 310). For example, as described in detail in the exemplary protocol shown below, the UPS client and the UPS directory server may establish a TCP/IP connection and then perform various authentication procedures to control access to information relating to other UPS clients.

After the connection is established, the UPS client transmits geographic information (e.g., ZIP code, latitude/longitude or the like) and communications network location information (e.g., the UPS client's IP address) to the directory server (Block 320). The directory server generates a categorization of the communications network location information based on the geographic information (Block 330). For example, as described in greater detail below, the categorization may occur responsive to a request from a UPS client, e.g., a request for communications network location information for UPS clients meeting a particular geographic or other criterion. Communications network location information is then communicated from the UPS directory server to one or more UPS clients based on the categorization (Block 340). The receiving UPS client(s) may then communicate power status information based on this communications network location information (Block 350).

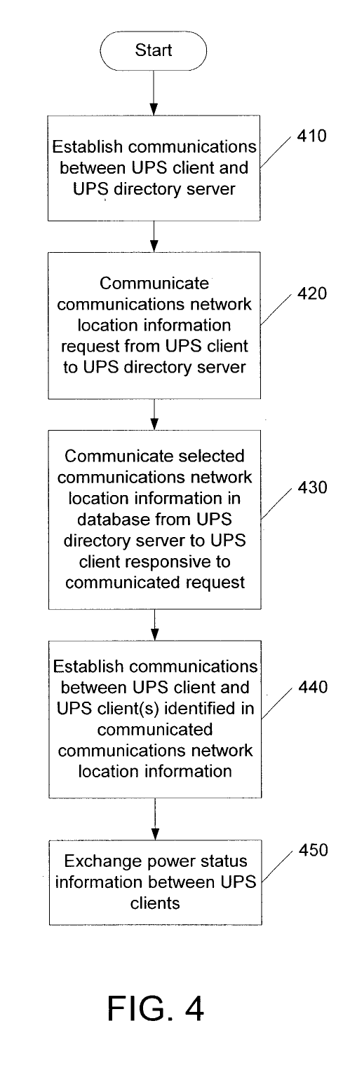

FIG. 4 illustrates exemplary operations according to further embodiments of the invention, in which a categorization of communications network location information is generated responsive to a request from a UPS client, and in which peer-to-peer communications are established between UPS clients based on the categorization of communications network location information. Communications between the UPS client and a UPS directory server are established using, for example, the negotiation operation outlined in the exemplary protocol below (Block 410). A request for communications network location information is then communicated from the UPS client to the UPS directory server (Block 420). The request may be geographically defined, e.g., the request may take the form of the LOCALE request of the exemplary protocol described below, which returns a LOCALE response comprising a list of UPS clients that meet a predetermined criterion based on distance from the requesting UPS client. Selected communications network location information is then responsively communicated from the UPS directory server to the requesting UPS client (Block 430). Peer-to peer-communications may then be established between the requesting UPS client and a UPS client associated with the communications network location information as described, for example, in the exemplary protocol below (Block 440). Power status information may then be exchanged between the UPS clients over the peer-to-peer link (Block 450) using, for example, the peer-to-peer communications protocol elements described below.

An Exemplary Protocol for Power Monitoring

An exemplary protocol for client-server and peer-peer communications according to some embodiments of the invention will now be described. It will be appreciated that the following description of an exemplary protocol provided solely for purposes of illustration, and that variations, additions, modifications and alternatives to the exemplary protocol fall within the scope of the invention. In the description of the exemplary protocol, certain requirements, such as constraints on the syntax of certain messages or the manner in which certain messages are transmitted, are described. It will be understood that these requirements are expressed only for purposes of describing “rules” under which the exemplary protocol operates, and do not constitute limitations on the scope of the present invention, as these constraints may be supplemented, reduced, replaced and otherwise altered within the scope of the invention. Generally, these are constraints are provided to define the given protocol; other collections of constraints may be used with other embodiments of the invention.

Directory Server Protocol

The Directory Server is accessible via the Internet and listens on port xxxxxx (the Directory Server port) for a TCP/IP connection from a node. The Directory Server must be able to handle multiple connections simultaneously and is unforgiving in message syntax.

Commands and Requests

The messages sent to and from the Directory Server are ASCII lines terminated by a <CRLF> end of line delimiter. Initially, the server host starts the Directory Server service by listening on TCP port xxxxxxx.

When a node wishes to make use of the service, it establishes a TCP connection with the server host. When the connection is established, the Directory Server sends a greeting or “identification”. The node and Directory Server then exchange commands or requests and responses (respectively) until the connection is closed or aborted.

Commands and Requests consist of a case-insensitive keyword, possibly followed by one or more arguments. All commands and requests are terminated by a <CRLF> pair. Keywords and arguments consist of printable ASCII characters. Keywords and arguments are each separated by a single SPACE character. Each argument may be up to 40 characters long.

The Directory Server proceeds through several states. After responding to an initial connection, it enters the AUTHENTICATION state. From AUTHENTICATION state the Directory Server progresses to the COMMAND/RETRIEVE state, then the REQUEST/DISPENSE state and finally to the COMPLETED state.

Commands and Requests come from the node to the Directory Server. Commands set information or dynamics in the Data Server either temporarily or permanently. The reply from the Directory Server indicates acceptance or rejection (a response). Requests cause the Directory Server to return information (a response). The reply from the Directory server to a Command or a Request is always termed a Response.

Responses

Responses consist of an ASCII line consisting of a status indicator and a keyword possibly followed by additional information. All Directory Server responses are terminated by a CRLF pair. Responses may be up to 512 characters long, including the terminating CRLF. There are currently two status indicators: positive (“+OK”) and negative (“−ERR”). Directory Servers MUST send the “+OK” and “−ERR” in upper case. Not all responses are one line. See the Locale Request. In the event of a multiple line response the indication that the multiple line response is concluded is an empty positive response.

Timeout Conditions

The basic timeout for the Directory Server is 60 seconds. A connection that remains idle for a period exceeding this standard value will have a “−ERR” response sent from the Directory Server to the node and the connection will be closed. The TIMEOUT keyword will be used to indicate this condition.

Additionally, the total connection time to the Directory Server cannot exceed 120 seconds at a time. A Timeout condition from the Directory Server will occur if either of these timers are exceeded.

The connecting node should not implement a timer. In the event an activity request for the Directory Server exceeds these values, the Directory Server will not terminate the connection. The Directory Server accumulates the idle time and not the processing time.

e.g.

−ERR TIMEOUT The PhoenixPSD Directory Server has timed out at Sep. 9, 2002 14:04:23. Closing Connection.<CRLF>

Identification, Authentication and Quit

Identification Response

Upon successfully receiving a connection on the Directory Server port the Directory Server will respond with a positive IDENT response.

Upon receiving this response the connecting node may begin a transaction with the server since the server will move into the AUTHENTICATION state. The identification string must contain a “[#.#]” string identifying the version of the Directory Server. The identification response will NOT contain a ‘<’ or a ‘>’ character at this time. The ‘[’ character will only occur once in the string.

e.g.

+OK IDENT Copyright 2002 [1.1] PhoenixPSD Server

Authentication

Authentication into the Directory server requires the USER command followed by the PASS command. Since the PASS command takes exactly one argument any spaces found within the argument will be considered part of the password.

The “anonymous” login is always present on the Directory Server. In this case, no information is assumed known about the node. The password for the anonymous account should be a valid email address associated with the connecting node. Only certain functionality will be available to any node logged in as “anonymous”.

User Command

The User command is required prior to the extraction of information from the Directory Server, and is required before the PASS command. It as formatted as follows:

USER <identificationString><CRLF>

The Identification string is the login code assigned to the node. This string is an arbitrary string whose minimum length is 6 characters and a maximum of 64. The string must begin with an alphabetical character (A-Z), may then contain only alphanumeric characters and no spaces. The identificationString is not case sensitive. “Anonymous” is the only reserved login name.

User Response

The User Response is positive unless the <identificationString>is illegal, another authentication process is used by the Directory Server or the account is locked since the account is already logged in. The anonymous account is the only account that can be logged into simultaneously. The USER keyword is used. The following are example responses that may be returned since the text description after the keyword is optional.

e.g.

+OK USER<CRLF>

+OK USER Username valid.<CRLF>

−ERR USER<CRLF>

−ERR USER Username invalid.<CRLF>

−ERR USER Secure login required.<CRLF>

−ERR USER Account locked.<CRLF>

Pass Command

The PASS command is required to immediately follow a successful USER command. After receiving the PASS command the Directory Server will attempt to validate the USER/PASS pair for authentication. If the pair is invalid, the Directory Server will remain in the Authentication state and will either require a QUIT command or another authentication attempt from the node. The nodepassword string is case sensitive. The nodepassword can be anywhere from 6 to 64 characters in length and may contain any valid printable ASCII text character including the space character.

The nodepassword will be issued to the node from an Administrator and cannot be modified by this protocol. The nodepassword for the “anonymous” account is by practice a valid email address of the node.

e.g.

PASS nodepassword<CRLF>

Pass Response

The Pass response uses the USER/PASS combination and indicates if the Directory server has remained in the authentication state or has proceeded to the RETRIEVE state. A positive/successful response indicates the RETRIEVE state has been entered.

e.g.

+OK PASS User logged in successfully.<CRLF>

−ERR PASS Bad authentication.<CRLF>

Quit Command

The Quit command can be sent while the Directory Server is in any state. The QUIT command will cause the Directory Server to begin termination of the connection. This is the proper method for ending the session with the Directory Server. For a successful and complete transaction with the Directory Server the Quit command should be issued to cause the Directory Server to enter the completed state. The Completed state causes possible database updates to occur.

e.g.

QUIT<CRLF>

Quit Response

The Quit Response uses the QUIT keyword. A positive response indicates that the Directory Server will terminate the connection.

e.g.

+OK QUIT Goodbye.<CRLF>

+OK QUIT<CRLF>

−ERR QUIT Cannot terminate.<CRLF>

Activity Record Keeping

The Directory Server keeps an activity flag associated with each login. A node that has not logged in to the Directory Server within the last 24 hours is termed as inactive.

By convention, nodes should (re) log onto the Directory Server every 12 hours. If a failure occurs, it should retry every hour.

Retrieve State Commands and Responses

The Directory Server may or may not have a database entry with completed information associated with the connecting node. In the case of an anonymous login, it does not exist, and in other cases the information may be partial. The following commands can be sent from the node to fill in the Directory Server database. In the event of anonymous, the information is never associated permanently with the anonymous account, though may be logged by the Directory Server for later analysis. In the event it is not anonymous, the new information is permanently associated with the nodes database entry unless otherwise specified.

Country Command

The Country command assigns to the Directory Server the country associated with the connecting node and is used to resolve a possible POST command. If the account is anonymous this is a temporary assignment (i.e., no database update since no record exists for anonymous). If the account is not anonymous, the database record will be updated. The United States and Canada are guaranteed to exist. The following Table matching keywords to country is currently defined:

| Keyword | Country |
|---|---|
| US | United States |
| CANADA | Canada |
| MEXICO | Mexico |
| ANTBAR | Antigua and Barbuda |
| ARUBA | Aruba |
| BAHAMAS | Bahamas |
| BARBADOS | Barbados |
| CAYMAN | Cayman Islands |
| CUBA | Cuba |
| DOMINICAN | Dominican Republic |
| GRENADA | Grenada |
| GUAD | Guadeloupe |
| HAITI | Haiti |
| JAMAICA | Jamaica |
| MARTIN | Martinique |
| PUERTO | Puerto Rico |
| KITTS | Saint Kitts |
| LUCIA | Saint Lucia |
| TRINTOB | Trinidad and Tobago |
| VIRGIN | Virgin Islands |
| BELIZE | Belize |
| RICA | Cost Rica |
| SALVADOR | El Salvador |
| GUAT | Guatemala |
| HOND | Honduras |
| NIC | Nicaragua |
| PANAMA | Panama |
| ARG | Argentina |
| BOLIVIA | Bolivia |
| BRAZIL | Brazil |
| CHILE | Chile |
| COLUMBIA | Columbia |
| ECUADOR | Ecuador |
| FRGUI | French Guiana |
| GUYANA | Guyana |
| PARAG | Paraguay |
| PERU | Peru |
| SURIN | Suriname |
| URUGUAY | Uruguay |

If the country command is never issued, the default country is US.

e.g.

COUNTRY US<CRLF>

COUNTRY CANADA<CRLF>

Country Response

The Country response indicates if the Directory Server contains a postal database for the requested country, i.e., if the POST command can be used to resolve geography information or not. A negative response can also exist if a failure of the database update occurs on a non-anonymous account.

e.g.

+OK COUNTRY<CRLF>

+OK COUNTRY Good<CRLF>

−ERR COUNTRY<CRLF>

−ERR COUNTRY Unsupported country<CRLF>

−ERR COUNTRY Bad update on record<CRLF>

Post Command

The Post command uses the keyword POST and informs the Directory Server of the node's postal location. Typically this is a U.S. ZIP code or Canadian Postal Code but can be any country-specific location identifier (key). This informs the Directory Server of the Postal location of the node. It can be used as the key for a request in the future. If the logged in user is not anonymous the database record will be updated.

Canadian codes can be sent with or without the space between the third and fourth character.

e.g.,

POST L5A 4A1<CRLF>

POST 90210<CRLF>

Post Response

The Post Response uses the keyword POST and indicates if an “acceptable” postal code was received and that the database was updated accordingly for a non-anonymous user. In the case of anonymous no database update will be attempted.

e.g.

+OK POST<CRLF>

+OK POST Postal code accepted<CRLF>

−ERR POST<CRLF>

−ERR POST Unknown <CRLF>

Latitude and Longitude Command

The Latitude and Longitude command uses the keyword LATLONG and informs the Directory Server of the node's latitude and longitude (in that order) in decimal form. If the node is not the anonymous login the database record will be updated. If the logged in user is anonymous no database record can be updated, but the command is a valid and the information remains valid while logged in to the Directory Server.

e.g.

LATLONG 34.0998-118.4128<CRLF>

LATLONG 35.8604-78.5416<CRLF>

Latitude and Longitude Response

The Latitude and Longitude response indicates if “acceptable” decimal coordinates were received and if the database was updated if the user was not anonymous.

e.g.

+OK LATLONG<CRLF>

−ERR LATLONG Bad format for lat and long<CRLF>

The Port Command

The Port command informs the Directory Server that the preferred port number to be connected to by other nodes is the decimal value following the PORT keyword. The database record of the logged in account is updated. This command is invalid for an anonymous log in. If the port command is never issued the default port of xxxxxx is assumed.

e.g.

PORT 1123<CRLF>

The Port Response

The Port response uses the PORT keyword and indicates if a properly formatted Port Command was received or if the record was successfully updated. An anonymous login will return an error since no database record exists for that login.

e.g.

+OK PORT<CRLF>

−ERR PORT<CRLF>

The IP Command

The IP Command informs the Directory Server that the preferred IP address to be connected to by other nodes is the 4-part dotted decimal value following the IP keyword or the URL name following the IP keyword. The database for a non-anonymous account is updated. This command is not valid for an anonymous login. If this command is never issued, the connecting physical IP address is used as derived from the current network packets (physip).

e.g.

IP 45.34.12.90<CRLF>

IP MICROSOFT.COM<CRLF>

The IP Response

The IP response uses the IP keyword and indicates the reception of a properly formatted IP Command. If the node is logged in under the anonymous account, an error will be returned.

e.g.

+OK IP<CRLF>

−ERR IP Cannot store info for anonymous<CRLF>

The Type Command

The Type command specifies the node type to the Directory Server. The default type (i.e., if the Type commands is never issued) is UPS. Currently the following keyword types are defined: UPS.

The type command sets the database type for a non-anonymous node and, determines the type used in any search unless overridden. (See Search). This command is invalid for the anonymous account.

e.g.

TYPE UPS<CRLF>

The Type Response

The Type response uses the TYPE keyword and indicates if the type keyword is valid.

+OK TYPE<CRLF>

−ERR TYPE Invalid type requested<CRLF>

The Search Command

The Search command specifies which node type should be used for searches (see locale and node requests). This command does not update any database entry and cannot be issued by the anonymous account without an error. See the Type command for valid types at this time.

e.g.

SEARCH UPS<CRLF>

The Search Response

The Search response uses the SEARCH keyword and indicates if the type keyword is valid.

+OK TYPE<CRLF>

−ERR TYPE Invalid type requested<CRLF>

The Units Command

The Units command specifies the distance measure to be used for all calculations returned by the Directory Server. If the Units command is never specified, by default the return values are in miles. The Units command takes one of two possible keywords: MILES or KILOMETERS both of which will always be supported by the Directory Server. This value is stored in the database of the logged in user.

e.g.

UNITS MILES<CRLF>

UNITS KILOMETERS<CRLF>

The Units Response

The Units Response uses the keyword UNITS and indicates the reception of valid keywords and syntax for the Units command.

e.g.

+OK UNITS<CRLF>

−-ERR UNITS Unrecognized units<CRLF>

The Address Command

The Address command sets the logged in account with the street address for the installed node. This address must correspond with the Postal or Zip code associated with the location of the node. This command is illegal for the anonymous account. This information may be used to increase the resolution of database lookups and as such, it may not necessarily be associated with the Name and Email physical locations which may be a service organization and not correspond to the physical location of the node.

The address command is a CSV (Comma Separated Variable) string consisting of up to a maximum of three fields. As such, the address may not contain commas, as these are used to differentiate fields. There must always be two commas passed to the Directory Server.

ADDRESS <streetaddressline1><streetaddressline2><city>

e.g.

ADDRESS 123 Main St., Toronto<CRLF>

ADDRESS 1145 Burard Rd., Suite 410, San Francisco<CRLF>

The Address Response

The Address response indicates the acceptance or decline of the Address command by the Directory Server. The ADDRESS keyword is used.

e.g.

+OK ADDRESS Address stored<CRLF>

−ERR Address too many or too few fields specified

−ERR ADDRESS illegal for anonymous<CRLF>

The Name Command

The Name command enables the storage of a contact name at the Directory Server. The name command will return an error on the anonymous account. It should be noted that there is no corresponding retrieval request in the protocol for a node to extract this information.

This is information for the Directory Server only. However, this name should correspond to the email address later specified by the Email command.

e.g.

NAME Tim Horton<CRLF>

The Name Response

The Name response indicates the acceptance or decline of the Name command by the Directory Server. The Name keyword is used.

e.g.

+OK NAME Name stored<CRLF>

−ERR NAME illegal for anonymous<CRLF>

The Email Command

The Email command specifies a contact email address. The Name command and the Email address can be used together in the event of service issues (node failure) etc. The EMAIL keyword is used. This command is invalid for the anonymous account.

e.g.

EMAIL timhorton@timbits.com<CRLF>

The Email Response

The Email response indicates the acceptance or decline of the Email command by the Directory Server. An error response can be caused by illegal syntax, illegal characters or use by the anonymous account.

e.g.

+OK EMAIL stored<CRLF>

−ERR EMAIL illegal for anonymous<CRLF>

The Manufacturer Command

The Manufacturer command sets the logged in account with a manufacturer string. The manufacturer is the name of the manufacturer of the node. This command is invalid for the anonymous account. This Directory Server information cannot be retrieved by a node request.

e.g.

MANUF Powerware<CRLF>

The Manufacturer Response

The Manufacturer response indicates the acceptance or decline of the Manufacturer command by the Directory Server. The MANUF keyword is used.

e.g.

+OK MANUF Name stored<CRLF>

−ERR MANUF illegal for anonymous<CRLF>

Calculation Requests and Responses

This section describes the Calculation commands and responses the Directory Server can perform.

The Vector Request

The Vector request can take three forms. It asks the Directory Server to return the distance and direction from the logged in node to the specified latitude and longitude, postal key or username. The Vector request can be made from any account including the anonymous account, but the username form will return an error. The Vector keyword is used, followed by the optional L, U, and P keyword.

e.g.,

VECTOR L 35.8604-78.5416<CRLF>

VECTOR U username<CRLF>

VECTOR P 90210<CRLF>

VECTOR P M5W 1E6<CRLF>

The Vector Response

A positive Vector response indicates that the distance and direction to the specified node or coordinates was obtained. Two numbers are returned separated by a space. The first number is the distance and the second number indicates the angle of direction between 0 to 359 degrees the specified coordinates can be found at the distance specified.

The Vector response can be negative for a number of reasons: if the connecting node is anonymous and the LATLONG or POST commands were not issued, an invalid username was presented, or there is insufficient information in the database to resolve the answer, or if the syntax of the request is invalid.

e.g.,

+OK VECTOR 23.8745 210.23<CRLF>

−ERR VECTOR<CRLF>

−ERR VECTOR Insufficient data.<CRLF>

The Locale Request

The Locale request asks the Directory Server to return a list of up to a maximum of 20 nodes closest to the logged in node. A node logged in as anonymous cannot issue this command and receive a successful response.

e.g.,

LOCALE<CRLF>

The Locale Response

The Locale response uses the keyword LOCALE and returns multiple lines-up to a maximum of the 20 closest nodes in the Directory Server's database. The order in which the nodes are returned is nearest to farthest according to the calculated distance. The currently set UNITS are used. The format is as follows:

+OK LOCALE <username><ipName><port><latitude><longitude><distance><direction><postal><phys_ip><activity><CRLF>+OK LOCALE <username><ipName><port><latitude><longitude><distance><direction><postal><phys_ip><activity><CRLF> . . . Up to 20 nodes (i.e., up to 18 more)+OK LOCALE<CRLF>

A Locale response that uses the LOCALE keyword and is immediately followed by the <CRLF> indicates the end of the list. This may be less than 20 total lines if 20 entries are not found as valid responses within the database. It should not be assumed that 20 nodes are always returned since additional rules may be applied to the radius from which the Directory Server may respond as a valid entry to the Locale request. It should be noted that zero nodes may be returned which is indicated by the only response being a +OK LOCALE<CRLF> line.

Multiple Locale requests will return the same information unless a new node has been added the Directory Server database between the time the two requests were made that falls within the Directory Server's rules for returning nodes. To obtain more nodes, see the Node Request.

The postal parameter is the postal code that is in the Directory Server's database. This field will contain no spaces. If the field is 0 there is no recorded postal code. The locale command will never return the logged in node.

Phys_ip is the actual physical IP address last used to connect to the Directory Server from the node. It may be 0.0.0.0 if it has never connected or the address is otherwise not available. It should be noted that the ipName may be 0.0.0.0 and in this case the node should attempt to connect to the phys_ip, unless it is 0.0.0.0 in which case no connection can be made.

If the port is reported as 0, the default port of xxxxxx should be used.

Activity is an integer number. A negative returned value indicates the node has not contacted the Directory Server in the last 24 hours, a zero or positive number indicates that it has. By convention, the degree of negative-ness indicates the number of days the node has been dormant. The degree of positive-ness is the consecutive number of days the node has been active.

e.g.

+OK LOCALE TOR145873 44.61.234.113 2145 34.0998-118.4128 0.143 92.33 M6W1E5 44.61.234.113 11<CRLF>

+OK LOCALE BEV726523 baywatch.com 14287 35.8604-78.5416 2145.0986 207.6 90210-0111 44.61.234.111 567<CRLF>

+OK LOCALE<CRLF>

−ERR LOCALE<CRLF>

−ERR LOCALE Invalid request<CRLF>

The Node Request

The Node request returns a single node entry line of the type returned by the Locale request instead of possible multiple lines.

The Node request is historically sensitive. If a previous Locale request has been made, or a previous Node request has been made, the Node request will return the next farthest node from the distance radius from the logged in node. If no previous Locale or Node request was made it will return the nearest node in terms of distance from the logged in node. This request will always return an error condition for an anonymous user.

e.g.

NODE<CRLF>

The Node Response

The Node response uses the keyword NODE and will return the next nearest node from the logged in node until there exists no more entries in the database or a rule internal to the Directory Server causes the list of nodes to be exhausted. The Node response is always a single line return.

To indicate an exhausted list the Directory Server will return an empty line, +OK NODE<CRLF>. Additional Node requests without an intervening Locale request will continue to return this exhausted list indication. An intervening Locale request will reset the list and the Node request will return the next entry after the Locale list, if possible as defined by the internal rules of the Directory Server.

e.g.

+OK NODE TOR145873 44.61.234.113 2145 34.0998-118.4128 0.143 92.33 M6W1 E5 44.61.234.113-2<CRLF>

or

+OK NODE<CRLF>

−ERR NODE Cannot calculate<CRLF>

−ERR NODE<CRLF>

Node to Node Protocol

Using the information supplied by the Directory Server, a node is able to establish node-to-node (peer-to-peer) connections. Connections between nodes are TCP/IP socket connections.

The protocol is unilateral, asynchronous, modeless and simplex. This means that once a one-time version and identification string is co-transmitted:

Utility information is the only information sent/received

Utility Information can be sent/received at any time

There is no acknowledgement to any Utility Information sent/received

And, there exists no mechanism for a node to request it

Through established TCP/IP connections, a node can only transmit its Utility Information and asynchronously receive Utility Information from the remote nodes.

The information is communicated via ASCII characters, terminated by a <CRLF>. Un-terminated strings must be ignored. Strings received that do not match a defined keyword or defined numeric syntax will be ignored and should not be used as a basis to terminate the connection.

Establishing a Node-to-Node Connection

After retrieving the node information from the Directory Server, a node can use the <ipName> to connect on <port> to another node. If the ipName is 0.0.0.0 the node should use the phys ip to connect to the node. If the port is 0, the node should use xxxxx to connect to the other node. If both the ipName and the phys ip are not 0.0.0.0 the node should first attempt connection on ipName and in the event of failure, attempt a connection with phys_ip.

The connection established between nodes is modeless. There exists no master or slave. As such, a node needs to never connect back to a node it has already received a connection from.

Upon connection a receiver (former listener) should determine if an existing connection already exists after a delay of 5 seconds plus a random wait time between 0 and 5 seconds. Once this time has expired (which allows the exchange of user names to complete) the receiver (former listener) should test and see if this connection is a redundant connection. If it is, it should terminate the connection immediately. The random wait time ensures that two nodes cannot become permanently deadlocked-simultaneously detecting redundant connections and reestablishing only to disconnect again.

There may be numerous reasons a connection cannot be established or is terminated. In the event that a connection cannot be established (i.e., no connection is ever made, and thus no exchange of data) any retry mechanism supported should not retry more frequently than once every 60 seconds, but can perform such a retry as many times as desired.

In the event of multiple quick disconnections (a connection, followed by identification strings (user name) exchange, followed by disconnection within 10 seconds later) a node will not retry more than 24 times per day, i.e., at a maximum of once per hour.

In the event of an asynchronous disconnection of two established and communicating nodes the nodes shall attempt to reconnect to each other in a random number of seconds between 0 and 60 to prevent a deadlock connection/disconnection scenario.

Fairness

The peer-to-peer network works by a mechanism of mutual benefit through the sharing of information and requires a foundation of fairness.

A node that does not provide sufficient Utility Information is deemed to be unfair in the network.

The basic rules are as follows:

A node shall provide Utility Information as quickly as possible after a major Utility failure or return event.

A node shall provide repeated, periodic updated Utility Information at a minimum of once every 30 seconds.

A node that refuses the establishment of a connection shall not be electronically harassed in that it may have reached a its maximum number of connections

If a node determines that the node it is connected to is unfair, it can terminate the connection at any time.

Authentication

There exists no authentication stage in the node-to-node connection. However, the first information transmitted on any established connection is a version string immediately followed by the nodes user name. The version string and user name string is transmitted by both the caller and receiver of the connection immediately upon connection. This is uniquely identifiable since the version is not only the first string transmitted followed by the <CRLF> end of message sequence followed by a name string but also that all Utility Information always begin with a number.

In the event that either of the two nodes receives a user name that they do not wish to maintain a connection with, the connection should be closed after a 2 second delay. This may also occur if the node has reached an arbitrary maximum number of connections, and wishes to not maintain any new connections.

Certain nodes may not care who is connecting to them, and is in fact the preferred node behavior. Other nodes may only wish to accept nodes that they have previously pulled from the Directory Server locale request. In this case, for newly added nodes, there may exist a window of 24 hours where a node cannot connect to a neighboring node.

Peer-to-Peer Protocol Definition

The following outlines the protocol to be used between nodes on the peer-to-peer network.

Version String

The Version string is the first data transmitted by any node on a newly established connection with another node. The keyword VERSION is used followed by a space and the version number. The version number for this version of the protocol is 1. It immediately precedes the Name string and in fact, they must be transmitted at the same time.

e.g.

VERSION 1<CRLF>

Name String

Upon immediate connection whether as a connector or receiver, a node will immediately transmit its version string, immediately followed by a user name string using the keyword NAME followed by the node's Directory Server user name and a <CRLF> message terminator. The user name from the Directory Server is case insensitive and can be transmitted in any format, however uppercase for alphabetic characters is recommended.

For coding purposes, the node in practice should send the version and name strings as a single network write.

e.g.

NAME TOR145873<CRLF>

Utility Information

The Utility Information is exchanged with numeric introduction constants as shown in the following Table:

| | | |
|---|---|---|
| 0 | Utility not present (mandatory) | NO PARAM |
| 1 | Utility present (mandatory) | NO PARAM |
| 2 | Utility Input Frequency Sample (optional) | Hz |
| 3 | Single Phase Utility Input Voltage Sample | Volts |
| | (optional) | |
| 4 | A-B Utility Input Voltage Sample (optional) | Volts |
| 5 | A-C Utility Input Voltage Sample (optional) | Volts |
| 6 | B-C Utility Input Voltage Sample (optional) | Volts |
| 7 | A-N Utility Input Voltage Sample (optional) | Volts |
| 8 | B-N Utility Input Voltage Sample (optional) | Volts |
| 9 | C-N Utility Input Voltage Sample (optional) | Volts |

Messages numbered 0 and 1 do not require a parameter to follow and must be supported by every node. They indicate the over-all state of the Utility power at the device as a binary measure: 0 indicating there is a Utility failure or “utility not present” and 1 indicating Utility is “present”. There is no space after the number and the <CRLF>end of message indicator.

This message should be sent as soon as is reasonably possible (as immediately as possible) by the node to all other connected nodes in the event of this parameter changing at the node. The other messages (3 through 6) are of lesser importance than the over-all state of the node's utility.

The exact definition of “utility present” and “utility not present” is a matter of some judgment. If a normal 120V Utility is operating at 98V is the Utility present or not? It is left to each node to implement an algorithm that maps “present” to “not present”. However, as a general rule, if a Utility is operating below a reasonable level, it should be considered not present.

Messages 3 through 6 require a parameter. This parameter follows a single space after the message number and is an exact point (a sample value) of the Utility to the best of the ability of the node. Specifically, this value is NOT an average, it is a sample at or very near the point in time transmitted. The value is expected to be a decimal number with an undetermined number of significant digits after the decimal point. Support of these messages is optional but highly recommended by all nodes.

All nodes are required to send messages 0 and 1. All other messages are optional. It may be that unit is a multiple phase box but only knows one phase-to-phase voltage. In this case, only that phase voltage message is transmitted. In terms of fairness, the sample values and the over-all state utility information should be transmitted once every 30 seconds. In the event of a state change (i.e., messages 0 and 1) these messages should be transmitted as soon as possible to all connected nodes if a change is determined in their values.

e.g.

0<CRLF>

1<CRLF>

2 59.88234<CRLF>

3 110<CRLF>

4 241.67363<CRLF>

5 240.444<CRLF>

It will be appreciated that the foregoing exemplary protocol is provided for purposes of illustration, and that the invention encompasses other power monitoring techniques. For example, a UPS client may be interested in monitoring power status on a basis other than geographical criteria, such as location in a communications network. For example, it may be advantageous to monitor UPS clients associated with UPSs that serve particular portions of a communications network, so that an impending loss or degradation of functionality in the network can be anticipated by detecting a change in power status at one of the monitored UPSs. Such information could be used, for example, to initiate shutdown, data protection and other contingency measures.

In the drawings and specification, there have been disclosed exemplary embodiments of the invention. Although specific terms are employed, they are used in a generic and descriptive sense only and not for purposes of limitation, the scope of the invention being defined by the following claims.

That which is claimed is:

1. A power monitoring system, comprising,
a plurality of uninterruptible power supplies (UPSs); and
a communications network comprising:
a plurality of UPS clients operative to monitor respective ones of the UPSs; and
a UPS directory server in communication with the UPS clients and operative to categorize the UPS clients.

2. A system according to claim 1, wherein the UPS directory server is operative to categorize the UPS clients based on categorization information received from the UPS clients.

3. A system according to claim 2, wherein the categorization information comprises at least one of location information, power distribution network information, and communications network information.

4. A system according to claim 2:
wherein the UPS clients are operative to communicate categorization information to the UPS directory server; and
wherein the UPS directory server is operative to generate a categorization of communications network location information for the UPS clients based on the communicated categorization information and to communicate communications network location information to the UPS clients based on the generated categorization.

5. A system according to claim 4, wherein the UPS clients are operative to communicate power status information based on the communications network location information communicated by the UPS directory server.

6. A system according to claim 5, wherein the UPS clients are operative to establish peer-to-peer communications links using the communications network location information communicated by the UPS directory server and to communicate the power status information over the peer-to-peer communications links.

7. A system according to claim 4:
wherein the UPS clients are operative to communicate requests for communications network location information to the UPS directory server; and
wherein the UPS directory server is operative to communicate communications network location information to the UPS clients responsive to the communicated requests.

8. A system according to claim 4, wherein the communications network location information comprises a network address.

9. A system according to claim 1, wherein the plurality of UPSs is coupled to a power distribution network, and wherein the UPS directory server is operative to associate communications network locations of the UPS clients with locations in the power distribution network

10. A system according to claim 1, wherein at least one of the UPS clients is implemented in a communications interface circuit of a UPS.

11. A system according to claim 1, wherein at least one of the UPS clients is implemented in a communications interface circuit of a data processing device powered by a UPS.

12. An apparatus, comprising:
a UPS directory server operative to communicate with a plurality of UPS clients coupled to respective UPSs and to responsively categorize the UPS clients.

13. An apparatus according to claim 12, wherein the UPS directory server is operative to categorize locations of the UPS clients based on categorization information received from the UPS clients.

14. An apparatus according to claim 13, wherein the categorization information comprises at least one of location information, power distribution network information, and communications network information.

15. An apparatus according to claim 13, wherein the UPS directory server is operative to generate a categorization of communications network location information for the UPS clients based on categorization information received from the UPS clients and to communicate communications network location information to the UPS clients based on the generated categorization.

16. An apparatus according to claim 13, wherein the UPS directory server is operative to communicate communications network location information to the UPS clients responsive to requests received from the UPS clients.

17. An apparatus according to claim 13, wherein the communications network location information comprises a network address.

18. An apparatus according to claim 12 wherein the UPS directory server is operative to associate communications network locations of the UPS clients with locations in a power distribution network.

19. An apparatus according to claim 12, wherein the UPS directory server is implemented in a computer coupled to the communications network.

20. A power monitoring apparatus, comprising:
a UPS client operative to monitor a UPS, the UPS client coupled to a UPS directory server in a communications network and operative to receive communications network location information for another UPS client from the UPS directory server and to responsively communicate power status information to the other UPS client based on the received communications network location information.

21. An apparatus according to claim 20, wherein the UPS client is operative to establish a peer-to-peer communications link with the other UPS client using the received communications network location information, and to communicate the power status information over the peer-to-peer communications link.

22. An apparatus according to claim 20, wherein the UPS client is operative to communicate a request for communications network location information for another UPS client to the UPS directory server.

23. An apparatus according to claim 20, wherein the UPS client is further operative to communicate communications network location categorization information for the associated UPS to the UPS directory server.

24. An apparatus according to claim 23, wherein the categorization information comprises at least one of location information, power distribution network information and communications network information.

25. An apparatus according to claim 20, wherein the communications network location information comprises a network address.

26. An apparatus according to claim 20, wherein the UPS client is implemented in a communications circuit integrated with the UPS.

27. An apparatus according to claim 20, wherein the UPS client is implemented in a communications interface circuit of a data processing device powered by the UPS.

28. A power monitoring method, comprising:
categorizing UPS clients, respective ones of which monitor respective uninterruptible power supplies (UPSs), responsive to categorization information received from the UPS clients at a UPS directory server.

29. A method according to claim 28, wherein the categorization information comprises at least one of location information, power distribution network information, and communications network information.

30. A method according to claim 28, further comprising communicating communications network location information from the UPS directory server to a first UPS client based on the categorization.

31. A method according to claim 30, further comprising communicating power status information between the first UPS client and a second UPS client based on the communicated communications network location information.

32. A method according to claim 31, wherein communicating power status information comprises:
establishing a peer-to-peer communications link between the first and second UPS clients based on the communicated communications network location information; and
communicating the power status information over the peer-to-peer communications link.

33. A method according to claim 28, wherein categorizing UPS clients comprises categorizing communications network locations of the UPS clients responsive to a request transmitted by a UPS client.

34. A method according to claim 33, wherein the communications network locations comprise a network address.

35. A computer program product comprising program code embodied in a computer-readable storage medium, the computer program code comprising:
UPS directory server program code configured to implement a UPS directory server operative to communicate with a plurality of UPS clients that monitor respective UPSs and to categorize the UPS clients.

36. A computer program product according to claim 35, wherein the UPS directory server is operative to categorize locations of the UPS clients in a communications network responsive to categorization information received from the UPS clients.

37. A computer program product according to claim 36, wherein the categorization information comprises at least one of location information, power distribution network information, and communications network information.

38. A computer program product according to claim 35, wherein the UPS directory server is further operative to communicate communications network location information to the UPS clients based on the categorization.

39. A computer program product according to claim 35, wherein the UPS directory server is operative to categorize the locations of the UPS clients in the communications network responsive to a request received from a UPS client.

40. A computer program product comprising program code embodied in a computer-readable storage medium, the computer program code comprising:
UPS client program code configured to establish a UPS client configured to monitor a UPS and to be coupled to a UPS directory server in a communications network, the UPS client operative to receive communications network location information for another UPS client from the UPS directory server and to responsively communicate power status information to the other UPS client based on the received communications network location information.

41. A computer program product according to claim 40, wherein the UPS client is operative to communicate requests for communications location information for other UPS clients to the UPS directory server.

42. A computer program product according to claim 41, wherein the UPS client is further operative to communicate categorization information to the UPS to the UPS directory server.

43. A computer program product according to claim 42, wherein the categorization information comprises at least one of location information, power distribution network information, and communications network information.
